(19) United States
(12) Patent Application Publication
(10) Pub. No.: US 2014/0169360 A1
(43) Pub. Date: Jun. 19, 2014

(54) APPARATUS AND METHOD FOR TRANSMITTING A SYNCHRONIZATION SIGNAL AND DETECTING A CELL ID ERROR

(71) Applicant: FUJITSU LIMITED, Kawasaki-shi (JP)

(72) Inventors: Junya MIKAMI, Kawasaki (JP); Mitsuo KOBAYASHI, Kawasaki (JP)

(73) Assignee: FUJITSU LIMITED, Kawasaki-shi (JP)

(21) Appl. No.: 14/059,030

(22) Filed: Oct. 21, 2013

(30) Foreign Application Priority Data
Dec. 14, 2012 (JP) 2012-274030

(51) Int. Cl. H04W 56/00

(52) U.S. Cl. CPC H04W 56/00
USPC 370/350

(57) ABSTRACT

A base station generates a frame timing signal corresponding to a cell ID of the base station based on a correspondence relation between a plurality of cell ID candidates and N frame timing candidates that are spaced in time from each other where N is a natural number equal to or greater than 2. The base station transmits a synchronization signal corresponding to the cell ID of the base station at specific timing corresponding to the generated frame timing signal.

### CROSS-REFERENCE TO RELATED APPLICATION

This application is based upon and claims the benefit of priority from the prior Japanese Patent Application No. 2012-274030, filed on Dec. 14, 2012, the entire contents of which are incorporated herein by reference.

### FIELD

The embodiments discussed herein are related to an apparatus and method for transmitting a synchronization signal and detecting a cell identifier (ID) error.

### BACKGROUND

In a wireless communication system, it is known to perform a process, called cell search, to detect a base station to which a terminal is to be connected. As the terminal moves, handover is performed to switch a connection of the terminal from one base station to another. In the handover processing, a cell search is also performed to detect a next base station to which the terminal is to be connected.

In the cell search, the terminal calculates a correlation value between a received signal and synchronization signal replicas. The terminal detects frame timing based on a peak of the correlation value and identifies a cell ID corresponding to a synchronization signal replica with a high correlation value. That is, a synchronization signal corresponding to a cell ID of a base station is transmitted from the base station. The terminal calculates a correlation value for each of the synchronization signal replicas while changing the synchronization signal replica, and the terminal detects frame timing and the cell ID using the calculated correlation values.

More specifically, in a wireless communication system based on 3rd Generation Partnership Project Radio Access Network Long Term Evolution (3GPP LTE), the synchronization signal includes a primary synchronization channel (PSC) code (signal) and a secondary synchronization channel (SSC) code (signal).

In each cell, PSC and SSC signals are periodically transmitted at every interval of 5 milliseconds.

First, a calculation is performed in time domain to determine a correlation value between a received signal of each center frequency (carrier frequency) candidate defined in the system and each of a predetermined number of types of PSC sequences. The correlation value obtained for a PSC sequence coincident with a PSC included in the received signal has peaks that appear repeatedly every 5 milliseconds. Therefore, by detecting a correlation peak, it is possible to detect a carrier frequency, PSC reception timing (at time intervals of 5 milliseconds), and a cell ID group including a cell to which the terminal is to be connected.

Thereafter, based on the detected PSC reception timing, a correlation value between the received signal and each of SSC sequences at SSC reception timing is calculated. Frame timing with intervals of 10 milliseconds and a cell ID are then detected from an SSC sequence having a highest correlation value.

A description of related techniques may be found, for example, in Japanese Laid-open Patent Publication No. 2010-45545.

### SUMMARY

According to an aspect of different embodiments herein, an apparatus generates a frame timing signal corresponding to a cell identifier (ID) of the base station based on a correspondence relation between a plurality of cell ID candidates and N frame timing candidates that are spaced in time from each other where N is a natural number equal to or greater than 2. The apparatus transmits a synchronization signal corresponding to the cell ID of the base station at specific timing corresponding to the generated frame timing signal.

The object and advantages of certain embodiments herein will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a base station according to an embodiment.

FIG. 2 is a block diagram illustrating an example of a generation unit according to the embodiment.

FIG. 3 is a block diagram illustrating an example of a terminal according to the embodiment.

FIG. 4 is a diagram illustrating frame timing of a base station according to an embodiment.

FIG. 5 is a block diagram illustrating an example of a base station according to another embodiment.

FIG. 6 is a block diagram illustrating an example of a terminal according to another embodiment.

FIG. 7 is a diagram illustrating an example of a hardware configuration of a base station according to an embodiment.

FIG. 8 is a diagram illustrating an example of a hardware configuration of a terminal according to an embodiment.

### DESCRIPTION OF EMBODIMENTS

There is a possibility that an error may occur in detecting a cell ID during a cell search. For example, two types of detection errors are: (1) a cell ID of a base station that is not located close to the terminal is detected; and (2) a cell ID of a base station located close to the terminal is not detected.

When a detection error of the type (1) occurs, a process (for example, a sequence of measuring a reception level) using the cell ID of the base station that does not exist nearby is uselessly performed. As a result, a processing load imposed on the terminal increases, and a resource of the terminal is uselessly consumed.

Certain embodiments disclosed herein provide a base station, a terminal, a method of transmitting a synchronization signal, and a method of making a judgment on a detection error. Certain embodiments are capable of judging whether a detected cell ID is correct thereby allowing a reduction in processing load imposed on the terminal.

A base station, a terminal, a method of transmitting a synchronization signal, and a method of making a judgment on a detection error according to certain embodiments are described in detail below with reference to drawings. Note that the embodiments described below are only for illustration purpose and not for limitation. Parts having functions that are similar among the embodiments are denoted by similar reference symbols, and a duplicated description thereof is omitted.

Configuration of Base Station

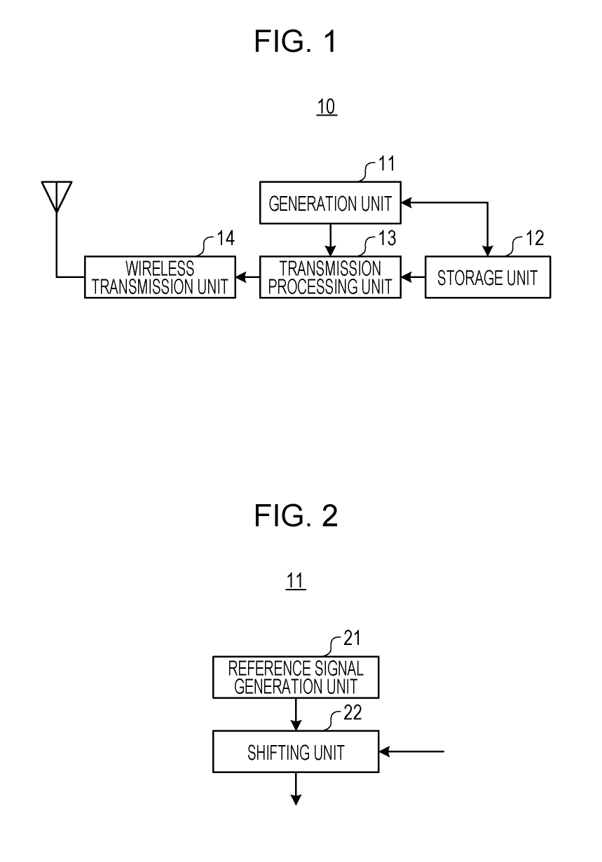

FIG. 1 is a block diagram illustrating an example of a base station according to an embodiment. As illustrated in FIG. 1, the base station 10 includes a generation unit 11, a storage unit 12, a transmission processing unit 13, and a wireless transmission unit 14.

The generation unit 11 generates a frame timing signal corresponding to a cell ID of the base station 10 based on relationships between a plurality of cell ID candidates and N frame timing candidates (N is a natural number equal to or greater than 2) which are spaced in time from each other. Each of the N frame timing candidates is spaced from its adjacent frame timing candidates by 1/N times one frame period. The N frame timing candidates are related to the cell ID candidates such that each cell ID candidate is related to a frame timing candidate corresponding to a remainder that occurs when the cell ID candidate is divided by N.

More specifically, as illustrated in FIG. 2, the generation unit 11 includes a reference signal generation unit 21 and a shifting unit 22.

The reference signal generation unit 21 generates a reference timing signal and outputs it to the shifting unit 22. The reference timing signal corresponds to a reference frame timing signal. More specifically, for example, the reference timing signal corresponds to a frame timing signal corresponding to a cell ID that results in a remainder of zero when the cell ID is divided by N.

The shifting unit 22 generates a frame timing signal by shifting the phase of the reference timing signal by an amount corresponding to the cell ID of the base station 10. More specifically, the shifting unit 22 shifts the phase of the reference timing signal by an amount corresponding to the product of a remainder obtained when the cell ID of the base station 10 is divided by N and 1/N frame, which is an offset unit. Note that the cell ID of the base station 10 is stored in the storage unit 12, and the reference signal generation unit 21 reads out the cell ID of the base station 10 from the storage unit 12.

The frame timing signal generated in the above-described manner is output to the transmission processing unit 13.

The transmission processing unit 13 periodically transmits a synchronization signal corresponding to the cell ID of the base station 10 via the wireless transmission unit 14 at specific timings according to the frame timing signal generated by the generation unit 11. The synchronization signal has M types of candidates (M is a natural number), and the transmission processing unit 13 uses, as the synchronization signal corresponding to the cell ID of the base station 10, a candidate corresponding to a remainder that occurs when the cell ID of the base station 10 is divided by M.

The wireless transmission unit 14 performs a predetermined wireless transmission process, which may include a digital-to-analog conversion, an upconversion, and the like, on the synchronization signal received from the transmission processing unit 13, and the wireless transmission unit 14 transmits a resultant signal via an antenna.

Configuration of Terminal

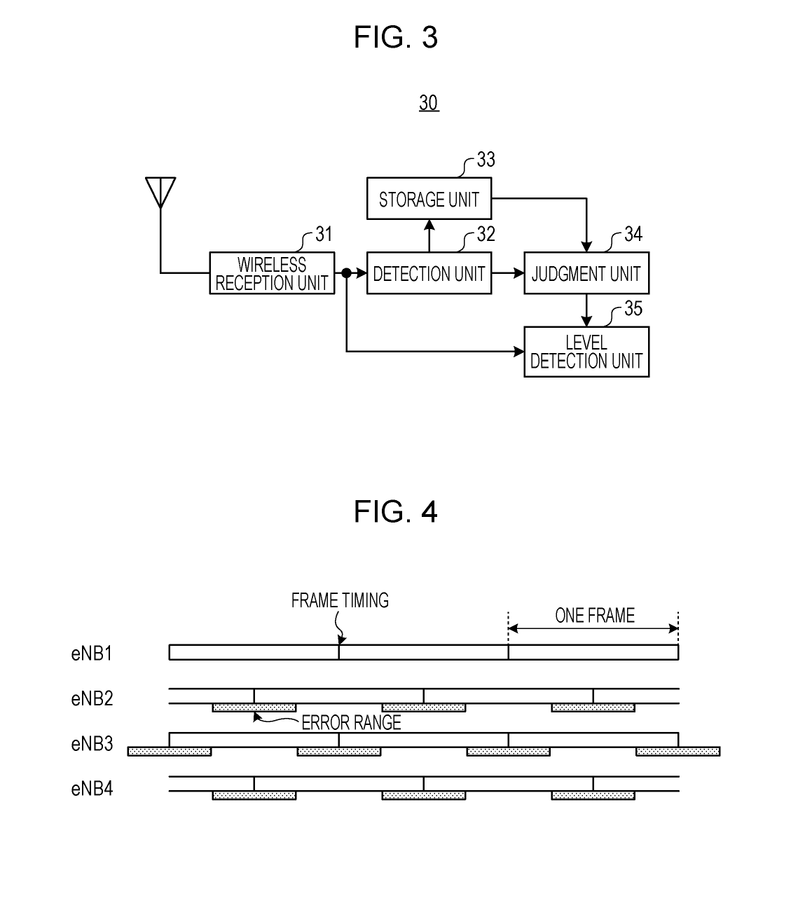

FIG. 3 is a block diagram illustrating an example of a terminal according to an embodiment. As illustrated in FIG. 3, the terminal 30 includes a wireless reception unit 31, a detection unit 32, a storage unit 33, a judgment unit 34, and a level detection unit 35.

The wireless reception unit 31 receives, via an antenna, a signal transmitted from the base station 10, and the wireless reception unit 31 performs a predetermined wireless reception process, which may include a downconversion, an analog-to-digital conversion, and the like, on the received signal. The wireless reception unit 31 outputs a resultant signal to the detection unit 32.

The detection unit 32 detects frame timing and a cell ID based on the received signal provided by the wireless reception unit 31 and a plurality of synchronization signal candidates, each synchronization signal candidate corresponding to a different one of the plurality of cell ID candidates. In the case of a wireless communication system based on 3GPP LTE, the detection unit 32 first detects a carrier frequency, PSC reception timing (at time intervals of 5 milliseconds), and a cell ID group. Based on the detected PSC reception timing, the detection unit 32 then calculates a correlation value between the received signal at the SSC reception timing and the SSC sequence, and the detection unit 32 detects frame timing and a cell ID based on a calculation result. That is, in the case of the wireless communication system based on the 3GPP LTE, the synchronization signal includes the PSC and the SSC, and the number, M, of types of PSC is 3.

The detection unit 32 stores the detected frame timing and cell ID in the storage unit 33.

The storage unit 33 stores the frame timing and the cell ID detected by the detection unit 32. Note that the storage unit 33 has already stored a cell ID and frame timing of a serving cell that is a cell to which the terminal 30 is currently in connection with.

The judgment unit 34 judges whether the detected cell ID is correct or not such that in a case where the frame timing and the cell ID detected by the detection unit 32 do not satisfy the correspondence relation between the plurality of the cell ID candidates and the N frame timing candidates that are spaced in timing from each other, where N is a natural number equal to or greater than 2, the judgment unit 34 judges that the detected cell ID is incorrect. Note that the correspondence relation used here is the same as that used in the base station 10.

More specifically, the judgment unit 34 reads out, from the storage unit 33, the cell ID of the serving cell and the frame timing. The judgment unit 34 also reads out the frame timing and the cell ID detected by the detection unit 32.

In a case where the frame timing detected by the detection unit 32 is consistent with the frame timing that corresponds to the detected cell ID and is obtained based on the correspondence relation with reference to the frame timing of the serving cell, the judgment unit 34 judges that the detected cell ID is correct. On the other hand, in a case where the frame timing detected by the detection unit 32 is inconsistent with the frame timing that corresponds to the detected cell ID and is obtained based on the correspondence relation with reference to the frame timing of the serving cell, the judgment unit 34 judges that the detected cell ID is incorrect. In other words, in a case where a difference between the frame timing of the serving cell and the frame timing detected by the detection unit 32 corresponds to a difference between the cell ID of the serving cell and the cell ID detected by the detection unit 32, the judgment unit 34 judges that the detected cell ID is correct. On the other hand, in a case where the difference between the frame timing of the serving cell and the frame timing detected by the detection unit 32 does not correspond to the difference between the cell ID of the serving cell and the cell ID detected by the detection unit 32, the judgment unit 34 judges that the detected cell ID is incorrect. That is, a judgment whether the frame timing and the cell ID detected by the detection unit 32 satisfy the correspondence relation described above is performed by checking the relative relation between the cell ID of the serving cell and the frame timing. Depending on the judgment result, it is determined whether the detected ID is correct.

Thereafter, the judgment unit 34 outputs, to the level detection unit 35, a command signal for commanding the level detection unit 35 to measure a reception level of a signal transmitted from a base station 10 corresponding to the cell ID that has been determined to be correct. However, in a case where the cell ID has been determined to be incorrect, the judgment unit 34 does not output to the level detection unit 35, a command signal for commanding the level detection unit 35 to measure a reception level of a signal transmitted from a base station 10 corresponding to the cell ID that has been determined to be incorrect. Therefore, needless processing using a cell ID of a base station 10 that does not exist nearby is not performed. Thus, no increase occurs in processing load imposed on the terminal 30, and needless consumption of a resource of the terminal 30 does not occur.

In accordance with the command signal from the judgment unit 34, the level detection unit 35 measures the reception level of the signal transmitted from the base station 10 corresponding to the cell ID specified by the command signal.

Operations of Base Station and Terminal

Processing operations associated with the base station 10 and the terminal 30 configured in the above-described manner are described below.

In the base station 10, the generation unit 11 generates a frame timing signal corresponding to the cell ID of the base station 10 based on the correspondence relation between N frame timing candidates, which are spaced in time from each other, and a plurality of cell ID candidates (where N is a natural number equal to or greater than 2).

FIG. 4 is a diagram illustrating frame timing of a base station according to the an embodiment. In the example illustrated in FIG. 4, for simplicity of illustration, it is assumed that N=2. Furthermore, in FIG. 4, four base stations 10 eNB1 to eNB4 are illustrated. Herein, the term “cell” is defined by an area covered by each base station 10, that is, an area within which a signal transmitted from a base station 10 located in this area is reachable or a subarea (also called a sector in an area), and a frequency. For simplicity of illustration, it is assumed that there is a one-to-one correspondence between cells and base stations. In FIG. 4, eNB2 and eNB4 have no remainder when their cell IDs are divided by N=2, and thus these cells are in the same group. On the other hand, eNB1 and eNB3 have a remainder of 1 when their cell IDs are divided by N=2, and thus these cells are in another same group. Note that the frame timing is the same for any eNB in the same group.

The transmission processing unit 13 periodically transmits a synchronization signal corresponding to the cell ID of the base station 10 via the wireless transmission unit 14 at specific timings according to the frame timing signal generated by the generation unit 11.

On the other hand, in the terminal 30, the detection unit 32 detects frame timing and a cell ID based on the received signal and a plurality of synchronization signal candidates, each synchronization signal candidate corresponding to a different one of the plurality of cell ID candidates.

The judgment unit 34 judges whether the detected cell ID is correct or not such that in a case where the frame timing and the cell ID detected by the detection unit 32 does not satisfy the correspondence relation between the plurality of the cell ID candidates and the N frame timing candidates that are spaced in time from each other, where N is a natural number equal to or greater than 2, the judgment unit 34 judges that the detected cell ID is incorrect.

More specifically, in a case where a difference between the frame timing of the serving cell and the frame timing detected by the detection unit 32 corresponds to a difference between the cell ID of the serving cell and the cell ID detected by the detection unit 32, the judgment unit 34 judges that the detected cell ID is correct. For example, in the case of the example illustrated in FIG. 4, when a cell ID detected by the detection unit 32 is 3, and detected frame timing is the same as that of a serving cell with a cell ID=1, then the judgment unit 34 judges that the detected cell ID is correct. On the other hand, when a cell ID detected by the detection unit 32 is 3, but detected frame timing is different from that of the serving cell with the cell ID=1, and more specifically, for example, when the detected frame timing is the same as that of a cell with a cell ID=2, the judgment unit 34 judges that the detected cell ID is incorrect. To take errors into account in the judgment, error ranges may be set as illustrated in FIG. 4. That is, in a case where the frame timing detected by the detection unit 32 is within an error range around frame timing determined based on the correspondence relation of the detected cell ID with respect to the frame timing of the serving cell, the judgment unit 34 judges that the detected cell ID is correct.

More specifically, the judgment process is performed as follows.

First, from the fact that each frame has a length of 10 milliseconds, the value of the offset is determined according to a formula (1) described below.

T-shift=(Cell-ID%N-grp)×10/N-grp [ms] (1)

where Cell-ID denotes a cell ID and % is a remainder operator.

The detection error judgment process may be performed by the terminal 30, for example, according to an algorithm described below:

FT-judge=FT-srv+((Cid-det%N-grp)−(Cid-srv%N-grp))×10/N-grp [ms]

If (|FT-det−FT-judge|>10/(2N-grp))

Then

C-err=true

Else

C-err=false

Endif

where N-grp denotes the number of groups, FT-srv denotes the frame timing of the serving cell, Cid-srv denotes the cell ID of the serving cell, FT-det denotes the frame timing of the detected cell, Cid-det denotes the cell ID of the detected cell, and C-err denotes a result of the detection error judgment (C-err has a value “true” when the detection is judged as being incorrect).

In the present embodiment, as described above, in the base station 10, the generation unit 11 generates the frame timing signal corresponding to the cell ID of the base station 10 based on the correspondence relation between the N frame timing candidates, which are spaced in time from each other, and the plurality of cell ID candidates (where N is a natural number equal to or greater than 2). The transmission processing unit 13 periodically transmits a synchronization signal corresponding to the cell ID of the base station 10 via the wireless transmission unit 14 at specific timings according to the frame timing signal generated by the generation unit 11.

This makes it possible for the terminal 30 to judge whether the detected cell ID is correct or not based on whether the frame timing and the cell ID detected by the detection unit 32 satisfy the correspondence relation described above.

Note that the synchronization signal has M types of candidates, where M is a natural number. It is preferable that synchronization signals assigned to cells in the same group are as different from each other as possible to reduce interference that may occur when similar synchronization signals are transmitted at the same timing. For this reason, it is preferable that M is smaller than N, and it is more preferable that M and N are prime to each other.

The synchronization signal is transmitted at every interval equal to 1/L times one frame period, where L is a natural number. In particular, in the case of a wireless communication system based on 3GPP LTE, L is 2. To minimize interference, it is desirable that synchronization signals are transmitted such that transmission timings are as different as possible. To this end, it is desirable that L is smaller than N, and it is more desirable that N and L are prime to each other.

Furthermore, when the type of synchronization signal and the transmission interval are both taken into account, it is desirable that N and a product of L and M are prime to each other.

More specifically, for example, when N=5, the probability for the detection to be incorrect is reduced by about 80% with respect to the probability for N=1.

In another embodiment described below, the value N indicating the number of frame timing candidates is variable.

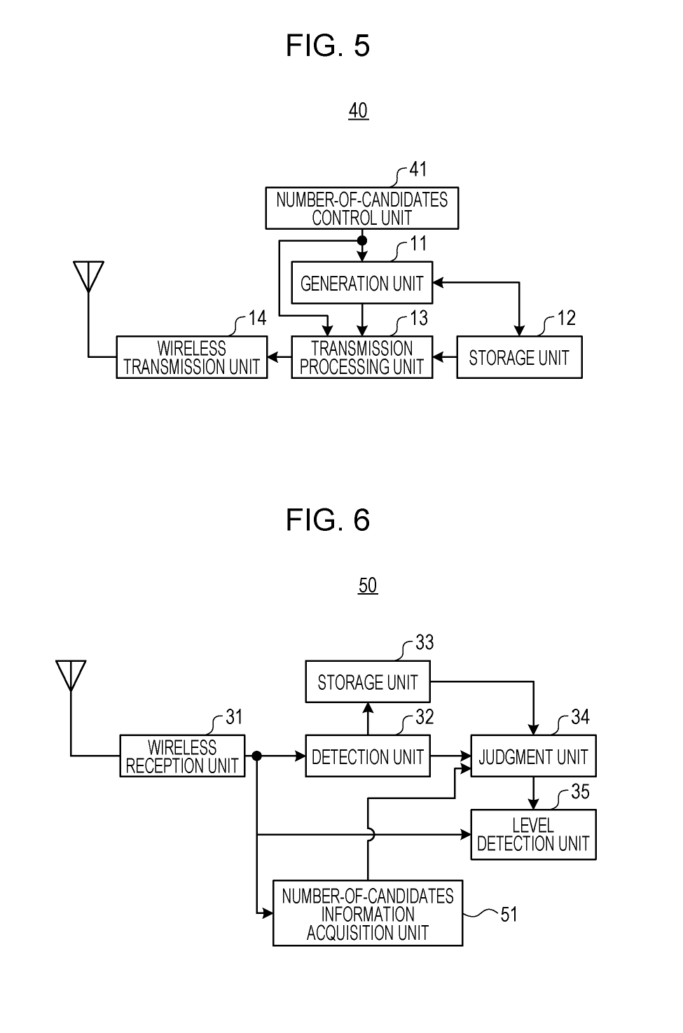

FIG. 5 is a block diagram illustrating an example of a base station according to this embodiment. In FIG. 5, a base station 40 includes a number-of-candidates control unit 41.

The number-of-candidates control unit 41 determines the number N of frame timing candidates and outputs the number N to the generation unit 11 and the transmission processing unit 13. For example, the number-of-candidates control unit 41 reduces N with increasing propagation delay in an environment in which the base station 40 is located. That is, the value of the offset described above decreases with N. Therefore, the increase in N results in an increase in a probability that the detected frame timing is different from actual frame timing. In other words, by reducing the value of N with increasing propagation delay in the environment in which the base station 40 is located, it is possible to reduce the detection error in detecting the frame timing.

The generation unit 11 generates a frame timing signal corresponding to the cell ID of the base station 40 using the value N indicating the number of frame timing candidates received from the number-of-candidates control unit 41.

When the transmission processing unit 13 receives the value of N indicating the number of frame timing candidates from the number-of-candidates control unit 41, the transmission processing unit 13 transmits the value of N via the wireless transmission unit 14. Note that the value N indicating the number of frame timing candidates may be transmitted using broadcast control channel (BCCH) or other control channels of data channels.

FIG. 6 is a block diagram illustrating an example of a terminal 50 according to an embodiment. In FIG. 6, the terminal 50 includes a number-of-candidates information acquisition unit 51.

The number-of-candidates information acquisition unit 51 extracts the value N indicating the number of frame timing candidates from the received signal and outputs the value N to the judgment unit 34.

The judgment unit 34 judges whether the cell ID detected by the detection unit 32 is correct or not based on the value N indicating the number of frame timing candidates received from the number-of-candidates information acquisition unit 51.

In this embodiment, as described above, the number-of-candidates control unit 41 in the base station 40 determines the number N of frame timing candidates. Using the number N of frame timing candidates received from the number-of-candidates control unit 41, the generation unit 11 generates the frame timing signal corresponding to the cell ID of the base station 40.

On the other hand, in the terminal 50, the number-of-candidates information acquisition unit 51 extracts the number N of frame timing candidates from the received signal, and outputs it to the judgment unit 34. Using the number N of frame timing candidates received from the number-of-candidates information acquisition unit 51, the judgment unit 34 judges whether the cell ID detected by the detection unit 32 is correct or not.

Thus, as described above, it is possible to vary the number N of frame timing candidates, which makes it possible to perform control in a more flexible manner.

### Other Embodiments

[1] The base station and the terminal according to the embodiments may be realized using hardware configurations as described below.

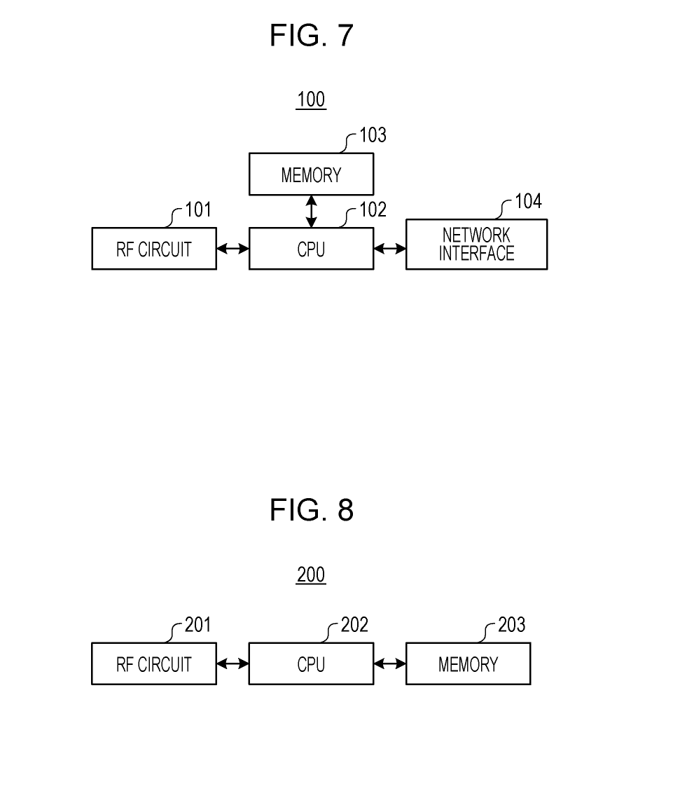

FIG. 7 is a diagram illustrating an example of a hardware configuration of a base station 100. As illustrated in FIG. 7, the base station 100 includes, as hardware configuration elements, a radio frequency (RF) circuit 101, a central processing unit (CPU) 102, a memory 103, and a network interface (IF) 104. The memory 103 may include, for example, a random access memory (RAM) such as a synchronous dynamic random access memory (SDRAM), a read only memory (ROM), a flash memory, or the like. The storage unit 12 is realized by the memory 103. The generation unit 11, the transmission processing unit 13, and the number-of-candidates control unit 41 is realized, for example, by an integrated circuit such as the CPU 102. The wireless transmission unit 14 is realized by the RF circuit 101.

FIG. 8 is a diagram illustrating an example of a hardware configuration of a terminal 200. As illustrated in FIG. 8, the terminal 200 includes, as hardware configuration elements, an RF circuit 201, a CPU 202, and a memory 203. The memory 203 may include, for example, a RAM such as an SDRAM, a ROM, a flash memory or the like. The storage unit 33 is realized by the memory 203. The detection unit 32, the judgment unit 34, the level detection unit 35, and the number-of-candidates information acquisition unit 51 is realized, for example, by an integrated circuit such as the CPU 202.

[2] Various processes described in the above embodiments may be realized by executing a program prepared in advance on a computer. More specifically, for example, programs corresponding to processes performed by the generation unit 11, the transmission processing unit 13, the number-of-candidates control unit 41 may be stored in the memory 103, and the programs may be read out and executed by the CPU 102 thereby achieving the processes. Similarly, programs corresponding to processes performed by the detection unit 32, the judgment unit 34, the level detection unit 35, and the number-of-candidates information acquisition unit 51 may be stored in the memory 203, and the programs may be read out and executed by the CPU 202 thereby achieving the processes.

All examples and conditional language recited herein are intended for pedagogical purposes to aid the reader in understanding the embodiments described herein and the concepts contributed by the inventor to furthering the art, and are to be construed as being without limitation to such specifically recited examples and conditions, nor does the organization of such examples in the specification relate to a showing of the superiority and inferiority of the embodiments described herein. Although the embodiments of the present invention have been described in detail, it should be understood that the various changes, substitutions, and alterations could be made hereto without departing from the spirit and scope of the invention.

What is claimed is:

1. A base station comprising:
a processor configured:
to generate a frame timing signal corresponding to a cell identifier (ID) of the base station based on a correspondence relation between a plurality of cell ID candidates and N frame timing candidates that are spaced in time from each other where N is a natural number equal to or greater than 2, and
to transmit a synchronization signal corresponding to the cell ID of the base station at specific timing corresponding to the generated frame timing signal; and
a memory configured to store the cell ID.

2. The base station of claim 1, wherein
the N frame timing candidates are shifted in timing between each adjacent frame timing candidates by 1/N times one frame period, and
each cell ID candidate corresponds to a frame timing candidate corresponding to a remainder that occurs when the cell ID candidate is divided by N.

3. The base station of claim 2, wherein
the synchronization signal has M types of candidates where M is a natural number, and
M is smaller than N.

4. The base station of claim 3, wherein
M and N are prime to each other.

5. The base station of claim 2, wherein
the synchronization signal is transmitted at every interval equal to 1/L times one frame period where L is a natural number, and
L is smaller than N.

6. The base station of claim 5, wherein
N and L are prime to each other.

7. The base station of claim 2, wherein
the synchronization signal has M types of candidates where M is a natural number, and the synchronization signal is transmitted periodically at every interval equal to 1/L times one frame period where L is a natural number, and
N and a product of L and M are prime to each other.

8. The base station of to claim 1, wherein
the processor determines a number N defined as a number of frame timing candidates, and
the processor transmits the determined number N.

9. The base station of claim 8, wherein
the processor determines the number N, based on a magnitude of a propagation delay.

10. A terminal comprising:
a processor configured:
to detect frame timing and a cell identifier (ID), based on a received signal and each synchronization signal candidate included in a plurality of synchronization signal candidates, each of the plurality of synchronization signal candidates corresponding to a different one of a plurality of cell ID candidates, and
to judge whether the detected cell ID is correct such that in a case where the detected frame timing and the detected cell ID do not satisfy a correspondence relation between a plurality of cell ID candidates and N frame timing candidates that are spaced in time from each other where N is a natural number equal to or greater than 2, the judgment unit judges that the detected cell ID is incorrect; and
a memory configured to store the cell ID.

11. The terminal of claim 10, wherein
the N frame timing candidates are shifted in timing between each adjacent frame timing candidates by 1/N times one frame period, and
each cell ID candidate corresponds to a frame timing candidate corresponding to a remainder that occurs when the cell ID candidate is divided by N.

12. The terminal of claim 11, wherein
the plurality of synchronization signal candidates include M types of candidates where M is a natural number, and
M is smaller than N.

13. The terminal of claim 12, wherein
M and N are prime to each other.

14. The terminal of claim 11, wherein
the received signal includes a synchronization signal at every interval equal to 1/L times one frame period where L is a natural number, and
L is smaller than N.

15. The terminal of claim 14, wherein
N and L are prime to each other.

16. The terminal of claim 11, wherein
the plurality of synchronization signal candidates include M types of candidates where M is a natural number,
the received signal includes a synchronization signal at every interval equal to 1/L times one frame period where L is a natural number, and
N and the product of L and M are prime to each other.

17. The terminal of claim 10, wherein
the processor extracts, from the received signal, a value of N determined at a base station and indicating a number of frame timing candidates; and
the processor judges whether the detected cell ID is correct or not, based on the extracted value of N indicating the number of frame timing candidates.

18. A method of transmitting a synchronization signal, the method comprising:
generating a frame timing signal corresponding to a cell identifier (ID) of a base station, based on a correspondence relation between a plurality of cell ID candidates and N frame timing candidates that are spaced in time from each other where N is a natural number equal to or greater than 2; and
transmitting the synchronization signal corresponding to the cell ID of the base station at a timing corresponding to the generated frame timing signal.

19. A method of detecting an error, the method comprising:
detecting frame timing and a cell identifier (ID) based on a received signal and each synchronization signal candidate included in a plurality of synchronization signal candidates, each of the plurality of synchronization signal corresponding to a different one of a plurality of cell ID candidates; and
judging whether the detected cell ID is correct such that in a case where the detected frame timing and the detected cell ID do not satisfy a correspondence relation between a plurality of cell ID candidates and N frame timing candidates that are spaced in time from each other where N is a natural number equal to or greater than 2, the detected cell ID is judged as being incorrect.
